(19) United States
(12) Patent Application Publication
(10) Pub. No.: US 2025/0018291 A1
(43) Pub. Date: Jan. 16, 2025

(54) IMAGE RENDERING METHOD AND RELATED APPARATUS

(71) Applicant: Tencent Technology (Shenzhen) Company Limited, Shenzhen (CN)

(72) Inventor: Shili XU, Shenzhen (CN)

(21) Appl. No.: 18/901,630

(22) Filed: Sep. 30, 2024

Related U.S. Application Data
(63) Continuation of application No. PCT/CN2023/126380, filed on Oct. 25, 2023.

(30) Foreign Application Priority Data
Dec. 19, 2022 (CN) 202211633880.7

(51) Int. Cl. A63F 13/52; A63F 13/60; G06T 5/50

(52) U.S. Cl. CPC A63F 13/52; A63F 13/60; G06T 5/50; G06T 2207/20221

(57) ABSTRACT

This application provides an image rendering method performed by a computer device, the method including: determining, in a game screen, a target game object that changes in a next frame of the game screen and a corresponding change parameter of the game object; dividing the game screen into a plurality of regions; determining, among the plurality of regions, a first region and a second region, the first region being affected by the change parameter of the target game object in the next frame, and the second region not affected by the change parameter of the target game object in the next frame; re-rendering the first region based on the change parameter of the target game object, to obtain a first updated region; and splicing the first updated region and the second region, to obtain an updated game screen displayed in the next frame.

### CROSS-REFERENCE TO RELATED APPLICATIONS

This application is a continuation application of PCT Patent Application No. PCT/CN2023/126380, entitled “IMAGE RENDERING METHOD AND RELATED APPARATUS” filed on Oct. 25, 2023, which claims priority to Chinese Patent Application No. 202211633880.7, entitled “IMAGE RENDERING METHOD AND RELATED APPARATUS”, and filed with the China National Intellectual Property Administration on Dec. 19, 2022, both of which are incorporated herein by reference in their entirety.

### FIELD OF THE TECHNOLOGY

This application relates to the field of computer technologies, and in particular, to image rendering.

### BACKGROUND OF THE DISCLOSURE

Currently, to provide better gaming experience for players, many game applications are constantly pursuing rendering and displaying a game screen at a higher frame rate, so that the player obtains smoother operating experience.

In the related art, a common manner for improving a game screen frame rate is as follows. Image quality of a single-frame game screen is reduced to reduce workload required for rendering the single-frame game screen, so that a rendering duration of the single-frame game screen is shortened, to support obtaining a higher frame rate. However, reducing the image quality of the single-frame game screen inevitably causes a loss to the game experience of the player. In other words, reducing the image quality of the single-frame game screen to improve the frame rate of the game screen does not fundamentally improve the game experience of the player.

### SUMMARY

Embodiments of this application provide a method and a related image rendering apparatus, which can effectively improve a frame rate of a game screen, and ensure that game experience of a player does not undergo other losses.

Based on this, a first aspect of this application provides an image rendering method, the method including:
determining, in a game screen, a target game object that changes in a next frame of the game screen and a corresponding change parameter of the game object;
dividing the game screen into a plurality of regions;
determining, among the plurality of regions, a first region and a second region based on the change parameter of the target game object;
re-rendering the first region based on the change parameter of the target game object, to obtain a first updated region; and
splicing the first updated region and the second region, to obtain an updated game screen displayed in the next frame.

A second aspect of this application provides a computer device, including a processor and a memory;
the memory being configured to store a computer program; and
the processor being configured to perform, based on the computer program, operations of the image rendering method according to the first aspect.

A third aspect of this application provides a non-transitory computer-readable storage medium, the computer-readable storage medium being configured to store a computer program, and the computer program, when executed by a processor of a computer device, being configured to cause the computer device to perform operations of the image rendering method according to the first aspect.

It can be seen from the foregoing technical solutions that the embodiments of this application have the following advantages.

The embodiments of this application provide an image rendering method. In the method, a target game object that causes a change in a currently displayed game screen and a change parameter of the target game object are first determined. Based on the change parameter of the target game object, a first region and a second region are determined in a plurality of regions included in the game screen. The game screen is divided into the plurality of regions. The first region is a region in the game screen that is affected by the change parameter of the target game object in a next frame and in which display content is to change, and the second region is a region in the game screen that is not affected by the change parameter of the target game object and in which display content does not change. The display content of the first region is re-rendered based on the change parameter of the target game object, to obtain a first updated region. The first updated region and the second region are spliced, to obtain an updated game screen displayed in the next frame. In the foregoing method, region division procession is performed on the game screen; the first region in which the display content needs to change and the second region in which the display content does not need to change are determined based on the change parameter of the target game object in a game; only the display content of the first region is re-rendered; the display content of the second region keeps unchanged; and the first updated region obtained through re-rendering and the second region are spliced, to obtain the updated game screen displayed in the next frame. Because only a partial area in which the display content changes in the game screen is re-rendered for the next frame of the game screen, an amount of workload required to render the game screen can be reduced, so that a rendering duration of the game screen is shortened, and a higher frame rate is obtained without causing other losses to game experience of a player. Therefore, the game experience can be fundamentally improved.

### BRIEF DESCRIPTION OF THE DRAWINGS

FIG. 1 is a schematic diagram of an application scenario of an image rendering method according to an embodiment of this application.

FIG. 2 is a schematic flowchart of an image rendering method according to an embodiment of this application.

FIG. 3 is a schematic diagram of a game battle interface of a MOBA game according to an embodiment of this application.

FIG. 4 is a schematic diagram of a manner for dividing a game screen according to an embodiment of this application.

FIG. 5 is a schematic diagram of determining a candidate region according to an embodiment of this application.

FIG. 6 is a schematic diagram of determining a first region under a change parameter according to an embodiment of this application.

FIG. 7 is a schematic diagram of determining a first region under another change parameter according to an embodiment of this application.

FIG. 8 is a schematic flowchart of an implementation of an image rendering method according to an embodiment of this application.

FIG. 9 is a schematic diagram of an implementation of determining each first region in which each target game object is involved according to an embodiment of this application.

FIG. 10 is a schematic structural diagram of an image rendering apparatus according to an embodiment of this application.

FIG. 11 is a schematic structural diagram of a terminal device according to an embodiment of this application.

FIG. 12 is a schematic structural diagram of a server according to an embodiment of this application.

### DESCRIPTION OF EMBODIMENTS

To enable a person in the art to better understand the solution of this application, the following clearly and completely describes the technical solutions in the embodiments of this application with reference to the accompanying drawings in the embodiments of this application. Apparently, the described embodiments are only some of the embodiments of this application rather than all of the embodiments. All other embodiments obtained by a person of ordinary skill in the art based on the embodiments of this application without creative efforts shall fall within the protection scope of this application.

The specification, claims, and terms “first”, “second”, “third”, “fourth”, and the like (if any) of the foregoing accompanying drawings of this application are used to distinguish similar objects, but are unnecessarily used to describe a specific sequence or order. The data used in such a way is interchangeable in proper circumstances, so that the embodiments of this application described herein can be implemented in other sequences than the sequence illustrated or described herein. Moreover, the terms “comprise”, “include”, and any other variants thereof mean to cover the non-exclusive inclusion. For example, a process, method, system, product, or device that includes a list of operations or units is not necessarily limited to those operations or units that are clearly listed, but may include other operations or units not expressly listed or inherent to such a process, method, system, product, or device.

An image rendering method provided in the embodiments of this application may be performed by an electronic device having an image rendering capability. The electronic device may be a terminal device or a server. The terminal device includes but is not limited to a mobile phone, a computer, an intelligent voice interaction device, a smart home appliance, an in-vehicle terminal, an aircraft, and the like. The server may be an independent physical server, or may be a server cluster including a plurality of physical servers, or may be a cloud server, for example, a cloud server providing cloud gaming services.

Information (including but not limited to electronic device information, account information, operation information, and the like), data (including but not limited to stored data, feature data, operation data, and the like), and signals involved in the embodiments of this application are authorized by relevant objects or fully authorized by all parties, and collection, use, and processing of relevant data comply with relevant laws, regulations, and standards of relevant countries and regions. For example, data information such as a game event involved in the embodiments of this application is obtained under full authorization.

For case of understanding of an image rendering method provided in the embodiments of this application, an application scenario of the image rendering method is exemplarily introduced below by using an example in which the image rendering method is performed by a terminal device.

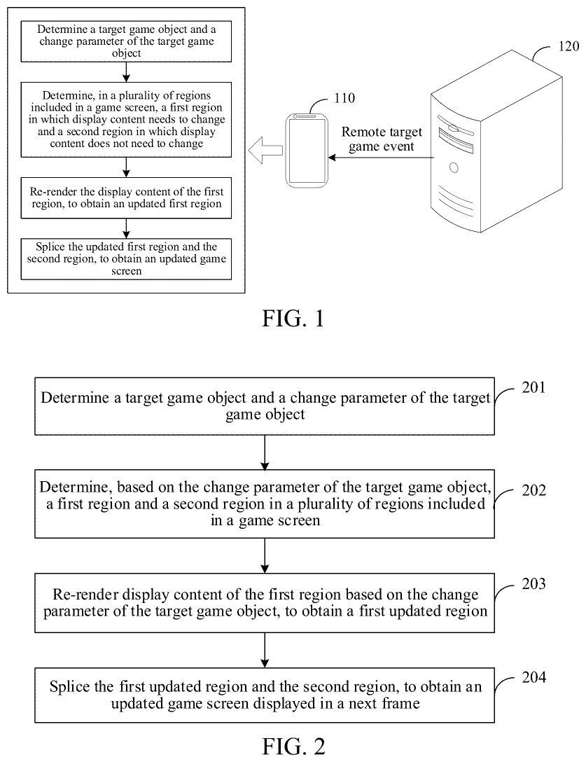

Referring to FIG. 1, FIG. 1 is a schematic diagram of an application scenario of an image rendering method according to an embodiment of this application. As shown in FIG. 1, the application scenario includes a terminal device 110 and a server 120. The terminal device 110 and the server 120 communicate through a network. A target game application runs on the terminal device 110. The terminal device 110 is configured to perform the image rendering method according to the embodiments of this application, to render a game screen in the target game application. The server 120 is a background server of the target game application. The server 120 is configured to transmit a target game event that can cause a change in the game screen to the terminal device 110.

In actual application, when the target game application on the terminal device 110 runs, the terminal device 110 may obtain a target game event that causes a change in a game interface of the target game application. For example, the terminal device 110 may obtain a local target game event. The local target game event is a game event generated when the target game application is used by a use object of the terminal device 110. The terminal device 110 may alternatively obtain a remote target game event. The remote target game event is a game event transmitted by the server 120, for example, may be a game event generated by another player using the target game application, or may further be, for example, a game event autonomously generated by the server 120.

Then, the terminal device 110 may determine, based on the obtained target game event, a target game object that can cause a change in a next frame in a currently displayed game screen of the target game application, and determine a change parameter of the target game object, for example, determine how a display style of the target game object changes, or determine how a display position of the target game object changes.

In addition, the terminal device 110 may determine, based on the change parameter of the target game object, a first region and a second region in a plurality of regions included in the game screen. The currently displayed game screen of the target game application is divided into the plurality of regions. Each region is configured for carrying display content of different areas in the game screen. Display content carried by all of the plurality of regions jointly form entire display content of the game screen. The determined first region is a region in the game screen that is affected by the change parameter of the target game object and in which display content needs to change, and the determined second region is a region in the game screen that is not affected by the change parameter of the target game object and in which display content does not need to change. In other words, each region included in the game screen is classified as the first region or the second region.

For the first region in which display content needs to change, the terminal device 110 needs to re-render the display content of the first region based on the change parameter of the target game object, to obtain a first updated region. For the second region in which display content does not need to change, the terminal device 110 does not need to perform any processing on the second region. Further, the terminal device 110 may splice the re-rendered first updated region with the second region that remains unchanged, to obtain an updated game screen displayed in the next frame, and display the updated game screen in the next frame of the target game application. In this way, only a partial area in which the display content changes in the game screen is rendered, so that an amount of workload required to render the game screen can be reduced, a rendering duration of the game screen is shortened, and a higher frame rate is obtained without causing another negative impact on game experience of the player.

The application scene shown in FIG. 1 is only an example. In actual application, the image rendering method provided in the embodiments of this application may alternatively be applied to another scenario. For example, when the target game application is a single-player game application or runs in a single-player mode, the terminal device 110 may independently perform the image rendering method provided in the embodiments of this application. For another example, when the target game application is a cloud game application, the image rendering method provided in the embodiments of this application may be independently performed by the server 120. The application scenario of the image rendering method provided in the embodiments of this application is not limited herein.

The image rendering method provided in this application is described in detail below through method embodiments.

Referring to FIG. 2, FIG. 2 is a schematic flowchart of an image rendering method according to an embodiment of this application. For ease of description, the following embodiments are introduced by using an example in which the image rendering method is performed by a terminal device. As shown in FIG. 2, the image rendering method includes the following operations.
Operation 201: Determine a target game object and a change parameter of the target game object.

The target game object is a game object that changes in a next frame in a currently displayed game screen.

In this embodiment of this application, in a running process of the target game application installed on the terminal device, the terminal device may determine the target game object that can cause a change in the currently displayed game screen in the target game application, and determine the change parameter of the target game object.

The target game application in the embodiments of this application may be any game application, including but not limited to a multiplayer online battle arena (MOBA) game application, a shooting game application, a fighting game application, and the like. The target game application is not specifically limited in this embodiment of this application. The game screen in this embodiment of this application may be any display interface in the target game application, for example, a game hall interface, an item market interface, a setting interface, or a game battle interface in the target game application. The game screen is not specifically limited in this embodiment of this application.

The game object in this embodiment of this application may be any object that supports display of the game screen, including but not limited to a virtual character (for example, a virtual character controlled by a player using the terminal device through the target game application, a non-player character controlled by a background server of the target game application, or a virtual character controlled by another player in a game battle), prompt information (for example, information configured for prompting a score in the game battle or information configured for prompting an operation of the player), an operation control (for example, a control (such as a movement control, a skill casting control, an attack control, or a defense control) configured for controlling the virtual character to perform a specific action in the game battle interface, a setting control and a message viewing control in the game battle interface, a game mode selection control in the game hall interface, or an item purchase control in an item market interface), or map information (for example, a mini map displayed in the game battle interface). The game object is not specifically limited in this embodiment of this application.

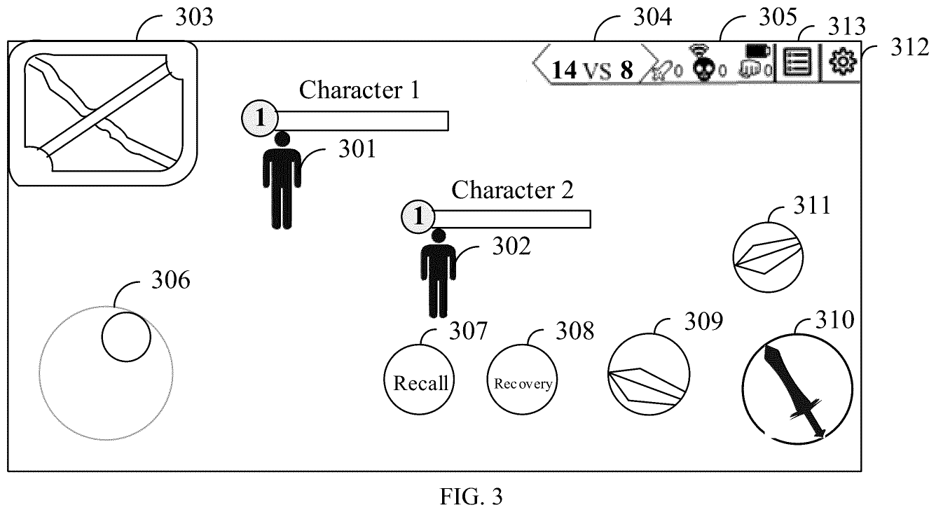

For example, FIG. 3 is a schematic diagram of a game battle interface of a MOBA game according to an embodiment of this application. A virtual character 301 and a virtual character 302 in a game battle are both game objects in this embodiment of this application. Prompt information 303 configured for prompting a score of the game battle, mini map information 304, and battle state prompt information 305 are also all game objects in this embodiment of this application. A game operation control 306, a game operation control 307, a game operation control 308, a game operation control 309, a game operation control 310, and a game operation control 311 are also game objects in this embodiment of this application. A set function control 312 and a message viewing control 313 are also game objects in this embodiment of this application. For another type of game screen, the game object included in the game screen may be another game object.

A target game object in this embodiment of this application is a game object that can cause a change in a currently displayed game screen in all game objects. To be specific, if display of a game object changes (including but not limited to a case in which a display position changes, a display size changes, and a display style changes), the game object may be considered as the target game object. A quantity of the target game objects may be one or more for one frame of the game screen. The quantity of the target game objects is not limited in this embodiment of this application.

The game screen shown in FIG. 3 is still used an example. For the virtual character (including a virtual character controlled by a player and an NPC) in the game battle interface, a control operation triggered by the player or the background server on the virtual character causes a change in display of the virtual character. In this case, the virtual character is the target game object. If an action performed by the virtual character under the control operation affects another virtual character in the game battle, the another affected virtual character is also the target game object. In addition, when the player triggers a control operation on the virtual character through the game operation control in the game battle interface, the display style of the game operation control is correspondingly changed. For example, a display position of a joystick in the game operation control for controlling the virtual character to move is changed. A skill casting control displays a skill casting effect, a skill cooldown countdown, and the like. In this case, the game operation control is the target game object. In addition, when the display position of the virtual character included in the mini map in the game battle interface changes, the mini map is the target game object. In addition, when the prompt information in the game battle interface changes, for example, a score in the game battle changes or the prompt information of the game operation for the player appears, the prompt information is the target game object. For another type of the game screen, the target game object included in the game screen may be another game object.

A change parameter of the target game object is information configured for reflecting a change of the target game object, such as information configured for reflecting a change of the display position of the target game object, information configured for reflecting a change of the display size of the target game object, or information configured for reflecting a change of the display style of the target game object. A change specifically reflected by the change parameter of the target game object is not limited in this embodiment of this application.

For example, the change of the target game object may be divided into the following situations. (1) The target game object changes because of an operation triggered by the player through the target game application, and this change is generally reflected in the virtual character (the player triggers the control operation on the virtual character to cause a direct change in the display of the virtual character, and may further cause an indirect change in the display of another virtual character) in the game battle interface and the operation control (the player triggers an operation through the operation control to cause a change in the display of the operation control) in the game battle interface. (2) The target game object changes automatically with time, and this change is generally reflected in an operation control having a cooldown setting (a countdown or a countdown progress bar is displayed on the operation control, and changes automatically with time), a game battle countdown, and the NPC in the game battle interface (the NPC in the game battle changes automatically with time). (3) The target game object changes because of a system event, such as a display change generated because of a countdown end event or a display change generated because of a game battle start event. It is clear that, in actual application, the change of the target game object is not limited to the foregoing situations, but may alternatively be another type of change. The change of the target game object is not limited in this embodiment of this application.

In a possible implementation, the terminal device may determine the target game object and the change parameter of the target game object in the following manner: obtaining a target game event, the target game event being an event that causes a change in the currently displayed game screen; determining a game object involved in the target game event as the target game object; and determining the change parameter of the target game object based on an impact of the target game event on a display status of the target game object.

For example, the terminal device may obtain a local target game event and a remote target game event. The local target game event is an event generated by a use object of the terminal device triggering a related operation through the target game application. For example, the terminal device may generate the local target game event for representing a control operation of the virtual character in response to the control operation of the virtual character triggered by the use object through the operation control in the target game application. The remote target game event herein is a game event transmitted by the background server of the target game application and configured for indicating the change in the currently displayed game screen. The remote target game event may be a game event configured for representing the control operation of the virtual character triggered by another player in the game battle, or may be a game event configured for representing a control operation of the NPC in the game battle.

Further, the terminal device may determine the game object involved in the target game event as the target game object based on the target game event obtained by the terminal device. For example, for the local target game event, the terminal device may determine, based on the control operation of the virtual character represented by the target game event, that the virtual character controlled by the control operation of the virtual character is the target game object, and determine that an operation control used when the control operation of the virtual character is triggered is the target game object. For another example, for the remote target game event, the terminal device may determine, based on the control operation of the virtual character represented by the target game event, that the virtual character controlled by the control operation of the virtual character is the target game object. In addition to determining that the game object directly affected by the target game event is the target game object, the terminal device further needs to determine that a game object indirectly affected by the target game event is the target game object. For example, it is assumed that the target game event is that a virtual character a is controlled to cast an attack skill, and an operation result of the target game event is that a virtual character b within a skill attack range is attacked, in this case, both the virtual character a and the virtual character b are target game objects.

Then, for the determined target game object, the terminal device may determine the change parameter of the target game object based on a target game event affecting display of the target game object. For example, for the target game object affected by the target game event representing the control operation of the virtual character, when the target game object is the virtual character directly controlled by the control operation of the virtual character, an action that needs to be performed by the virtual character indicated by the control operation of the virtual character is correspondingly represented as the change parameter of the target game object. For example, when the control operation of the virtual character indicates the virtual character to move leftward, the change of the target game object is that the display position moves leftward. For another example, the control operation of the virtual character indicates the virtual character to cast a skill, the change of the target game object is that the display style is changed to a skill casting style. When the target game object is the virtual character indirectly affected by the control operation of the virtual character, a display effect caused by the target game object affected by the control operation of the virtual character is the change of the target game object. For example, when the control operation of the virtual character indicates the virtual character a to attack the virtual character b, the change of the virtual character b is an attacked display effect. When the target game object is the operation control used when the control operation of the virtual character is triggered, a corresponding triggered effect of the operation control is the change of the target game object. If the target game object is affected by a plurality of target game events at the same time, an impact of the plurality of target game events on the target game object needs to be comprehensively considered, to determine a change parameter for identifying the change of the target game object.

In this way, the target game object that can cause the change in the game screen and the change parameter of the target game object are determined in the foregoing manners. Therefore, accuracy and reliability of the determined target game object and the change parameter of the target game object can be ensured, and it is beneficial to accurately determining a region that needs to be re-rendered in the game screen subsequently.

In actual application, the target game object and the change parameter of the target game object may alternatively be determined by the background server of the target game application. The implementation of the background server specifically determining the target game object and the change parameter of the target game object is similar to the manner described above. Then, the background server notifies the terminal device of the target game object and the change parameter of the target game object.
Operation 202: Determine, based on the change parameter of the target game object, a first region and a second region in a plurality of regions included in the game screen.

The game screen is divided into the plurality of regions, the first region is a region in the game screen that is affected by the change parameter of the target game object in the next frame and in which display content is to change, and the second region is a region in the game screen that is not affected by the change parameter of the target game object in the next frame and in which display content does not change.

After determining each target game object that causes the change in the currently displayed game screen and each change parameter of each target game object, the terminal device may determine, based on each change parameter of each target game object, the first region in which the display content needs to change and the second region in which the display content does not need to change in the plurality of regions included in the game screen, that is, each region included in the game screen is classified into the first region or the second region.

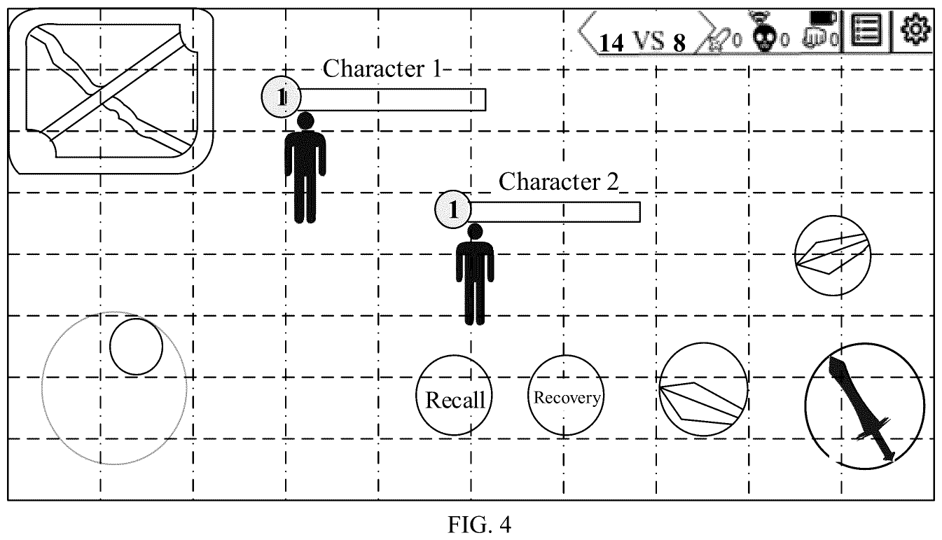

In this embodiment of this application, the game screen has been divided into the plurality of regions based on a preset division manner, that is, display content carried by the plurality of regions jointly constitutes entire display content of the game screen. For example, FIG. 4 is a schematic diagram of a manner for dividing a game screen according to an embodiment of this application. As shown in FIG. 4, a terminal device may use several horizontal lines and vertical lines to divide the game screen into a specific quantity of independent regions. In FIG. 4, nine horizontal lines and seven vertical lines are used as an example to divide a game into 80 regions. In actual application, the terminal device may alternatively divide the game screen into a plurality of regions in other manners. For example, the terminal device may use another quantity of horizontal lines and vertical lines to divide the game screen into another quantity of equal regions. In another example, the terminal device may alternatively divide, based on display content carried in the game screen, the game screen into a plurality of regions configured for carrying different types of display content, including but not limited to a region configured for carrying an operation control, a region configured for carrying a game battle area, a region configured for carrying prompt information, a region configured for carrying a mini map, and the like. The division manner of the game screen is not limited in this embodiment of this application.

In addition, for each region in the game screen, the terminal device further needs to record a coordinate range corresponding to the region in a screen coordinate system, to determine, based on a change parameter of the target game object and the coordinate range corresponding to each region, a region in which display content needs to change and a region in which display content does not need to change.

A first region in this embodiment of this application is a region in the game screen that is affected by the change parameter of the target game object and in which display content needs to change. To be specific, the display content of the first region in a currently displayed game screen changes in an updated game screen displayed in a next frame. A second region in this embodiment of this application is a region in the game screen that is not affected by the change parameter of the target game object and in which display content does not need to change. To be specific, the display content of the second region in the currently displayed game screen does not change in the updated game screen displayed in the next frame. If a region in the game screen does not belong to the first region, the region belongs to the second region. In other words, each region in the game screen is classified into the first region or the second region correspondingly.

In this embodiment of this application, the target game object may be divided into the following types, to be specific, a first type of the target game object: a target game object displayed in the game screen both before and after the change; a second type of the target game object: a target game object that is not displayed in the game screen before the change and that is to be displayed in the game screen after the change; and a third type of the target game object: a target game object that is displayed in the game screen before the change and that disappears from the game screen after the change. For the foregoing three types of the target game object, the terminal device may determine the first region involved in the target game object in a corresponding manner. The following describes an implementation of determining the first region involved in the target game object.

For the first type of the target game object, the terminal device may determine a first candidate region set in a plurality of regions included in the game screen based on a display position of the target game object in the currently displayed game screen, each first candidate region included in the first candidate region set being configured for carrying the target game object before the change; determine a second candidate region set in the plurality of regions included in the game screen based on the display position of the target game object in the currently displayed game screen and the change parameter of the target game object, each second candidate region included in the second candidate region set being configured for carrying the target game object after the change; and determine the first region involved in the target game object based on the change parameter of the target game object, the first candidate region set, and the second candidate region set.

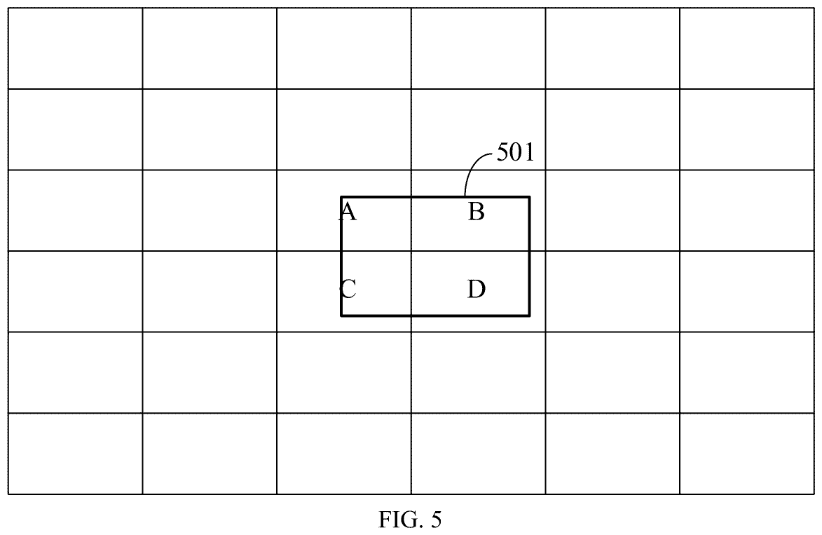

Specifically, the terminal device may determine the display position of the target game object in the currently displayed game screen, and then determine a region in the game screen that overlaps the display position as the first candidate region. The determined each first candidate region forms the first candidate region set. In addition, the terminal device may further determine, based on the display position of the target game object in the currently displayed game screen and the change parameter of the target game object, a display position of the target game object in an updated game screen displayed in the next frame, and then determine a region in the game screen that overlaps the display position in the next frame as the second candidate region. The determined each second candidate region forms the second candidate region set. FIG. 5 is a schematic diagram of determining a candidate region according to an embodiment of this application. As shown in FIG. 5, it is assumed that the display position of the target game object is a rectangle 501, and a region A, a region B, a region C, and a region D that overlap the rectangle 501 in the game screen are all candidate regions configured for carrying the game object. The candidate region includes the first candidate region and the second candidate region.

Further, the terminal device may determine the first region involved in a change of the target game object in the currently displayed game screen based on the change parameter of the target game object, the first candidate region set, and the second candidate region set.

For example, when the change parameter of the target game object indicates that neither of the display position and a display size of the target game object changes, the terminal device may determine each candidate region included in any one of the first candidate region set and the second candidate region set as the first region involved in the target game object.

Specifically, if the change parameter of the target game object indicates that both the display position and the display size of the target game object do not change, it indicates that only the display style of the target game object changes. In this case, a region that needs to be re-rendered in the game screen is a region originally involved in the target game object. To be specific, the first candidate region set involved in the target game object before the change is the same as the second candidate region set involved in the target game object after the change. The second candidate region set is essentially the first candidate region set. Therefore, the terminal device may determine each candidate region included in the first candidate region set or the second candidate region set to be the first region in which display content needs to be re-rendered.

Generally, the target game object with the change parameter is an operation control and prompt information in the game screen. For example, after a use object triggers an operation for the operation control, a display style of the operation control may change, such as displaying a skill casting effect and starting to display a cooldown countdown progress, but both a display position and a display size of the operation control do not change. For another example, in a game battle, the prompt information configured for prompting a score in the game battle may change with a game progress, but both a display position and a display size of the prompt information do not change.

For another example, when the change parameter of the target game object represents that the display position of the target game object changes, the terminal device may determine each first candidate region included in the first candidate region set and each second candidate region included in the second candidate region set as the first region involved in the target game object.

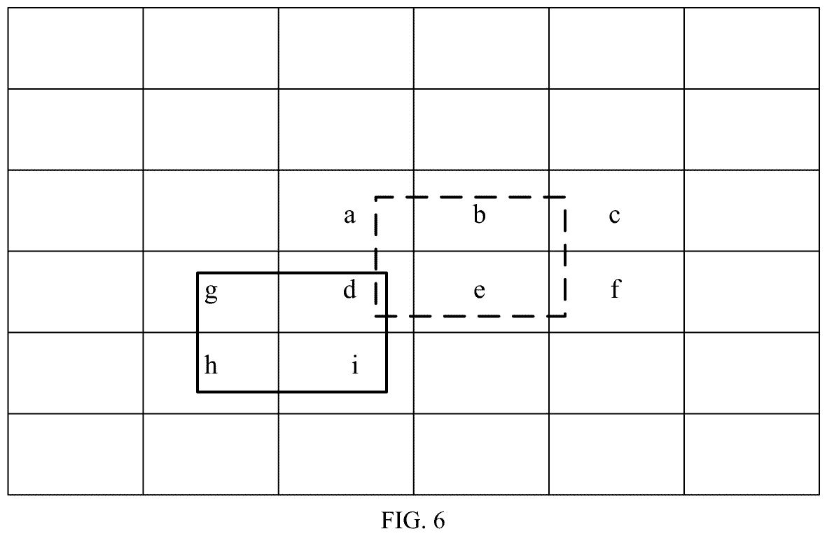

Specifically, the change parameter of the target game object represents that the display position of the target game object changes. In this case, regardless of whether the display size and the display style of the target game object change, the first candidate region configured for carrying the target game object before the change and the second candidate region configured for carrying the target game object after the change need to be re-rendered. Re-rendering the first candidate region configured for carrying the target game object before the change is intended to eliminate the carried target game object before the change, and re-rendering the second candidate region configured for carrying the target game object after the change is intended to construct the carried target game object after the change. In other words, each first candidate region configured for carrying the target game object before the change and each second candidate region configured for carrying the target game object after the change are considered as the first region involved in the target game object. FIG. 6 is a schematic diagram of determining a first region under a change parameter according to an embodiment of this application. As shown in FIG. 6, a dashed box represents the display position of the target game object before the change in the game screen, and a solid box represents the display position of the target game object after the change in the game screen. The first candidate region configured for carrying the target game object before the change includes a region a, a region b, a region c, a region d, a region e, and a region f. The second candidate region configured for carrying the target game object after the change includes a region g, a region d, a region h, and a region i. Then, the region a, the region b, the region c, the region d, the region e, the region f, the region g, the region h, and the region i are the first region involved in the target game object.

Generally, the target game object with the change parameter is a virtual character in the game screen. For example, after the use object of the terminal device triggers an operation of controlling movement of the virtual character, the corresponding virtual character in the game screen moves correspondingly. In this case, the display position of the virtual character changes.

For another example, when the change parameter of the target game object represents that a display size of the target game object changes, and the display position does not change, the terminal device may determine each second candidate region included in the second candidate region set as the first region if the display size of the target game object becomes larger; or the terminal device may determine each first candidate region included in the first candidate region set as the first region if the display size of the target game object becomes smaller.

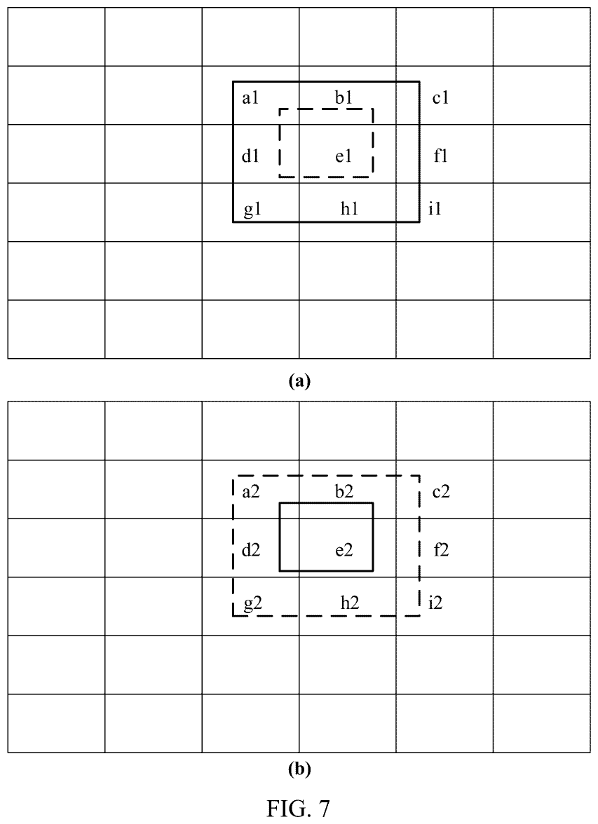

Specifically, the change parameter of the target game object represents that the display size of the target game object changes, but the display position does not change. In this case, the terminal device may determine a candidate region set with a larger coverage area in the first candidate region set and the second candidate region set, and then determine each candidate region included in the candidate region set as the first region involved in the target game object. FIG. 7 is a schematic diagram of determining a first region under a change parameter according to an embodiment of this application. As shown in (a) of FIG. 7, if the change parameter of the target game object represents that the display size of the target game object becomes larger, a dashed box represents the display position of the target game object in a game screen before the change, and a solid box represents the display position of the target game object in the game screen after the change. Because the display position represented by the solid box covers the display position represented by the dashed box, each region involved in the solid box may be determined as a first region involved in the target game object, to be specific, a region a1, a region b1, a region c1, a region d1, a region e1, a region f1, a region g1, a region h1, and a region i1 are determined as the first region. As shown in (b) of FIG. 7, if the change parameter of the target game object represents that the display size of the target game object becomes smaller, the dashed box represents the display position of the target game object in the game screen before the change, and the solid box represents the display position of the target game object in the game screen after the change. Because the display position represented by the dashed box covers the display position represented by the solid box, each region involved in the dashed box may be determined as the first region involved in the target game object, to be specific, a region a2, a region b2, a region c2, a region d2, a region e2, a region f2, a region g2, a region h2, and a region i2 are determined as the first region.

Generally, the target game object with the change parameter is a virtual character in the game screen. For example, after the use object of the terminal device triggers a zoom-in operation or a zoom-out operation on the virtual character, the virtual character in the game screen is correspondingly zoomed in or zoomed out based on an original display position.

In the foregoing implementation, whether the display position of the target game object changes and whether the display size of the target game object changes may be measured based on each first candidate region configured for carrying the target game object before the change and each second candidate region configured for carrying the target game object after the change. If the display position of each first candidate region does not cover the display position of each second candidate region, and the display position of each second candidate region does not cover the display position of each first candidate region, it indicates that the display position of the target game object may change. If a total display size of all first candidate regions is not the same as a total display size of all second candidate regions, it indicates that the display size of the target game object may change.

For the second type of the target game object, the terminal device may determine, based on the change parameter of the target game object, a position at which the target game object is to appear in a next frame of the game screen; and determine, based on the position to appear at, a region configured for carrying the target game object that is to appear in a plurality of regions included in the game screen as the first region involved in the target game object.

Specifically, for the target game object that is not displayed in the game screen before the change and that is to be displayed in the game screen after the change, the terminal device may determine the position at which the target game object is to appear in the game screen based on the change parameter of the target game object. For example, it is assumed that the target game object is a to-be-born virtual character, and a position at which the virtual character is to be born in the game screen is the position to appear at. For another example, it is assumed that the target game object is a virtual character that already exists in a game map, but the virtual character does not appear in a field of view of the use object of the terminal device (that is, the virtual character does not appear in the game screen displayed on a screen of the terminal device), a position at which the virtual character enters the field of view of the use object is the position to appear at of the target game object. The position to appear at is generally located at an edge position of the game screen.

Further, the terminal device may determine, based on the determined position to appear at of the target game object, the region configured for carrying the target game object that is to appear in the plurality of regions included in the game screen. In other words, an appearance area of the target game object in an updated game screen displayed in the next frame is determined based on the position to appear at of the target game object, and a region to which the appearance area belongs is determined as the first region involved in the target game object.

For the third type of the target game object, the terminal device may determine, based on the display position of the target game object in the currently displayed game screen and the change parameter of the target game object, a position at which a disappearance effect of the target game object is to be displayed in the next frame of the game screen. Further, based on the position to display at of the disappearance effect, a region configured for carrying the disappearance effect of the target game object is determined in the plurality of regions included in the game screen as the first region involved in the target game object.

Specifically, for the target game object that is displayed in the game screen before the change and that disappears from the game screen after the change, the terminal device may determine the position to display at of the disappearance effect in the game screen based on the display position of the target game object in the game screen and the disappearance effect (namely, the change parameter) of the target game object. For example, it is assumed that a target virtual object is a virtual character with an exhausted health point, then the virtual character needs to disappear from the game screen. In this case, the terminal device may determine a disappearance effect corresponding to the virtual character, and determine that a display area of the disappearance effect in the game screen is a position to display at of the disappearance effect. For example, when the disappearance effect corresponding to the virtual character is that transparency of the virtual character gradually increases until the virtual character becomes completely transparent, the display position of the virtual character in the game screen is the position to display at of the disappearance effect. For another example, when the disappearance effect corresponding to the virtual character is that the virtual character is split into several pieces and the pieces dissipate in the game screen, a dissipation area of the pieces in the game screen is the position to display at of the disappearance effect. It is clear that, in actual application, the disappearance effect of the target game object may alternatively be represented as another effect. The disappearance effect of the target game object is not limited in this embodiment of this application herein.

Further, the terminal device may determine, based on the position to display at of the disappearance effect of the target game object, the region configured for carrying the disappearance effect in the plurality of regions included in the game screen. In other words, based on the position to display at of the disappearance effect of the target game object, a display area of the disappearance effect in the updated game screen displayed in the next frame is determined, and a region to which the display area belongs is determined as the first region involved in the target game object.

In this way, the first region involved in the target game object that causes a change in the game screen is determined in the foregoing manner. Therefore, accuracy of the determined first region can be ensured, that is, that the first region accurately corresponds to the target game object is ensured, and a problem of miss-recognizing and mis-identifying the target game object corresponding to the first region is avoided.

After the terminal device determines the first region in the game screen in which the display content needs to change, that is, determines each first region involved in each target game object, the terminal device may consider the plurality of regions except the first region as the second region in which the display content does not need to change.
Operation 203: Re-render the display content of the first region based on the change parameter of the target game object, to obtain a first updated region.

For the determined first region in which the display content needs to change, the terminal device needs to re-render the display content of the first region, to obtain the corresponding first updated region.

Specifically, for each target game object, the terminal device may determine, based on the change parameter of the target game object, a specific change manner of displaying of the target game object, and determine a display form of the target game object in the next frame based on the change parameter of the target game object. Then, in the first region involved in the target game object, the display content of the first region is re-rendered based on the display form of the target game object in the next frame, to obtain the corresponding first updated region.

In a possible implementation, to further reduce an amount of workload consumed to render the game screen, when re-rendering the display content of the first region, the terminal device may render the display content in layers. Specifically, the terminal device may render an object layer corresponding to the target game object based on the change parameter of the target game object, to obtain a changed game layer of the first region. Different object layers are obtained through division based on different game objects in a game process. Further, the terminal device may perform superimpose processing on the changed game layer in the first region and an unchanged game layer in the first region, to obtain the first updated region.

The terminal device may perform layer division on the game screen based on the game object in the game process in advance, to obtain object layers corresponding to different game objects in the game screen. The game object corresponding to the object layers obtained through division is independent of each other. Based on this, in this embodiment of this application, when the terminal device re-renders the display content of the first region, the terminal device may render only an object layer corresponding to the changed target game object, and an object layer of a game object that has not changed in the first region may remain unchanged, so that the amount of workload consumed to render the game screen is further reduced.

For example, the terminal device may directly obtain the object layer corresponding to the game object in the game screen through division based on the game object included in the game screen, for example, obtain an object layer corresponding to each virtual character, an object layer corresponding to the prompt information, an object layer corresponding to each operation control, and an object layer corresponding to map information through division. It is clear that, in actual application, the terminal device may alternatively divide the object layers in another manner, for example, divide the object layers based on an impact of the game event, and for another example, divide the object layers based on a type of the game object. This is not limited in this embodiment of this application.

Correspondingly, after determining, through operation 202, the first region in the game screen in which the display content needs to change, the terminal device may render an object layer corresponding to the target game object in the first region, to obtain a changed object layer of the first region. In a specific implementation, a layer rendering manner used when the object layer corresponding to the target game object is rendered may be determined based on the change parameter of the target game object. The layer rendering manner may include at least one of layer re-rendering and layer parameter adjustment. Further, the layer rendering manner is used to render the object layer corresponding to the target game object. Different game events cause different changes to the game object, and different changes may be caused on different target game objects. Generally, change parameters of the game object may include the following types, to be specific: the display content of the game object changes, while a position and a size of the game object do not change (for example, displaying of the prompt information and displaying of the operation control); the position of the game object changes, while the display content and the size of the game object do not change (for example, displaying of a screen background changes when the virtual character moves); a form of the game object changes (for example, the size of the game object changes, or a posture of the game object changes); and a perspective of the screen changes while the display content of the object does not change (for example, when the use object switches the perspective, the perspective of the game screen changes, and the display content of the game screen changes with a change of the perspective).

Based on different change parameters of the target game object, corresponding layer rendering manners may be used. When the change parameter of the target game object indicates that the object layer changes greatly, the object layer corresponding to the target game object may be re-rendered. When the change parameter of the target game object indicates that the object layer changes little, there is no need to re-render the object layer corresponding to the target game object, and only information in the object layer needs to be adjusted. In different cases, the information that needs to be adjusted is different.

For example, when a display status (including the display content and the display form) of the target game object changes, it may be determined that the layer rendering manner used is a layer re-rendering manner. Then, the terminal device may re-render the object layer corresponding to the target game object, to obtain the changed object layer of the first region. For example, when a player triggers a getting changed operation of the virtual character for the virtual character, the display content of the virtual character changes greatly, and the object layer corresponding to the virtual character needs to be re-rendered. When the display status of the target game object does not change, but the display position changes, it may be determined that the layer rendering manner used is layer coordinate adjustment. Further, the terminal device may adjust coordinates of the object layer corresponding to the target game object, to obtain the changed object layer of the first region. For example, when only the position of the virtual character changes, the terminal device performs layer coordinate adjustment on the object layer corresponding to the virtual character. When the display status of the target game object does not change, and the display size changes, the terminal device may determine that the layer rendering manner used is layer size adjustment. Then, the terminal device may adjust the size of the object layer corresponding to the target game object, to obtain the changed object layer of the first region. For example, when the virtual character is zoomed in or zoomed out, the terminal device may perform a zoom-in operation or a zoom-out operation on the object layer corresponding to the virtual character.

After rendering the changed object layer of the first region, the terminal device may superimpose the changed object layer of the first region with the unchanged object layer of the first region (that is, an object layer not adjusted in the first region), to obtain the first updated region corresponding to the first region. Because the game event generally changes not only the display of the game object, but also a blocking order and display transparency of the game object. Therefore, when the changed object layer and the unchanged object layer of the first region are superimposed, different blocking effects may be implemented by adjusting the blocking order of the object layer, and the display transparency of the game object may be adjusted by adjusting the display transparency of the object layer. In other words, the terminal device needs to determine a layer display order and layer transparency of each object layer in the first region, each object layer including the changed object layer or the unchanged object layer; performs transparency adjustment on each object layer based on the layer transparency of each object layer; and performs superimpose processing on the object layer after the transparency is adjusted based on the layer display order, to obtain the first updated region.

In this way, the display content of the first region is adjusted in layers in the foregoing manner. Because there is no need to render each object layer corresponding to each game object in the first region, only the object layer corresponding to the target game object in which display changes need to be rendered. Therefore, resources consumed when the game screen is rendered can be further reduced, and rendering efficiency of the game screen can be further improved. For the determined second region in which the display content does not need to change, the terminal device does not need to perform other processing on the second region, and keeps the display content of the second region unchanged.
Operation 204: Splice the first updated region and the second region, to obtain an updated game screen displayed in the next frame.

After re-rendering each first region to obtain each first updated region, the terminal device may correspondingly splice each first updated region and each second region, to obtain the updated game screen displayed in the next frame. Specifically, a display position of each first updated region is the display position of a corresponding first region, and the display position of each second region remains unchanged. Then, each first updated region and each second region are spliced based on the display position of each region, to obtain the updated game screen, and the updated game screen is displayed in the next frame.

It is considered that if there are many first regions in the game screen, the terminal device re-renders the display content of each first region one by one, and consequently, an effect of reducing the processing resources required to render the game screen cannot be achieved. In other words, when the game screen includes many first regions, partially re-rendering the game screen through operation 203 and operation 204 may consume more processing resources. Therefore, to minimize the processing resources consumed to render each frame of the game screen, the terminal device may first determine, before performing operation 203, a proportion that the first region occupies in regions included in the game screen as a target proportion; then determine whether the target proportion exceeds a preset proportion threshold; and if yes, when the target proportion exceeds the preset proportion threshold, re-render entire display content of the game screen directly, to obtain the updated game screen displayed in the next frame; or if not, when the target proportion does not exceed the preset proportion threshold, normally perform operation 203 and operation 204, to obtain the updated game screen displayed in the next frame.

Specifically, after the terminal device performs operation 202, and determines each first region in the game screen, the terminal device may calculate the proportion that each first region occupies in the regions included in the game screen as the target proportion; then determine whether the target proportion exceeds the preset proportion threshold, where the preset proportion threshold may be set based on actual experience, for example, may be 50%. If the target proportion exceeds the preset proportion threshold, it indicates that a quantity of first regions in which the display content needs to change in the game screen is large. In this case, if the display content of the first regions is re-rendered one by one, the processing resources need to be consumed by a graphics processing unit (GPU) are large, and even exceed the processing resources required to re-render the entire game screen. Therefore, a solution for partially rendering in the region may not be performed, but the entire game screen may be directly re-rendered, to obtain the updated game screen displayed in the next frame. On the contrary, if the target proportion does not exceed the preset proportion threshold, it indicates that a quantity of first regions in which the display content needs to change in the game screen is not large. In this case, the processing resources consumed by the GPU can still be effectively reduced by using the solution for partially rendering in the region. Therefore, operation 203 and operation 204 can be normally performed to obtain the updated game screen displayed in the next frame.

In this case, in the foregoing manner, based on the proportion that the first region occupies in the regions included in the game screen, it is determined whether to render the game screen displayed in the next frame by using the solution of partially rendering in the region. In this way, the rendering solution for the game screen can be intelligently determined, and the updated game screen is ensured to be rendered by using the rendering solution that requires fewer processing resources. Therefore, the rendering efficiency of the game screen is further improved, and the processing resources consumed by the GPU are reduced.

In actual application, a large-scale change frequently occurs in the game screen in many scenes. The large-scale change may be understood as that most display content in the game screen needs to change. For this game screen, if the solution for partially rendering in the region provided in this embodiment of this application is used, the GPU consumes more processing resources. Based on this, in this embodiment of this application, whether to render the game screen by using the solution of partially rendering in the region is determined based on the scene corresponding to the game screen. In other words, the terminal device may determine whether the scene corresponding to the game screen is a preset target scene. If the scene corresponding to the game screen is not the preset target scene, when the scene corresponding to the game screen is not the preset target scene, the entire display content of the game screen is directly re-rendered, to obtain the updated game screen displayed in the next frame. If the scene corresponding to the game screen is the preset target scene, when the scene corresponding to the game screen is the target scene, operation 202 to operation 204 are performed, to obtain the updated game screen displayed in the next frame.

Specifically, the terminal device may obtain a preset target scene in advance. The target scene is a preset scene in which the solution of partially rendering in the region may be used to render the game screen. Generally, the target scene is a scene in which the large-scale change does not occur frequently in the game screen, such as a game hall scene, a game map loading scene, or a virtual character way-finding scene, and a scene other than the target scene is a scene in which the large-scale change occurs frequently in the game screen, for example, an intense team battle scene.

Based on the foregoing target scene, the terminal device may detect whether a scene corresponding to a currently displayed game screen belongs to the target scene. If the scene corresponding to the game screen belongs to the target scene, it indicates that the large-scale change does not occur frequently in the game screen displayed in a current stage. Therefore, the solution of partially rendering the game screen in the region provided in operation 202 to operation 204 may be performed, to reduce the processing resources consumed when the GPU renders the game screen. If the scene corresponding to the game screen does not belong to the target scene, it indicates that the large-scale change may occur frequently in the game screen displayed in the current stage. In this case, if the solution of partially rendering the game screen in the region provided in operation 202 to operation 204 is used, the GPU may consume more processing resources. Therefore, the terminal device may abandon performing operation 202 to operation 204, and perform overall re-rendering on the game screen directly based on the change parameter of the target game object, to obtain the updated game screen displayed in the next frame.

In this way, in the foregoing manner, it is detected whether the scene corresponding to the currently displayed game screen belongs to the preset target scene, and the rendering solution for the game screen is determined based on a detection result, so that the rendering solution for the game screen can be intelligently determined. Therefore, the processing resources consumed when the GPU renders the game screen is reduced as greatly as possible, and the rendering efficiency of the game screen is improved.

In the image rendering method provided in the embodiments of this application, region division processing is performed on the game screen. The first region in which the display content needs to change and the second region in which the display content does not need to change are determined in the regions included in the game screen based on the change parameter of the target game object in the game. Then, only the display content of the first region is re-rendered, and the display content of the second region remains unchanged. In addition, the first updated region obtained through re-rendering and the second region are spliced, to obtain the updated game screen displayed in the next frame. Only the partial area in which the display content changes in the game screen is re-rendered, so that an amount of workload required to render the game screen can be reduced, a rendering duration of the game screen is shortened, and a higher frame rate is obtained. In addition, the foregoing method does not cause other losses to the game experience of the player, and the game experience can be fundamentally improved.

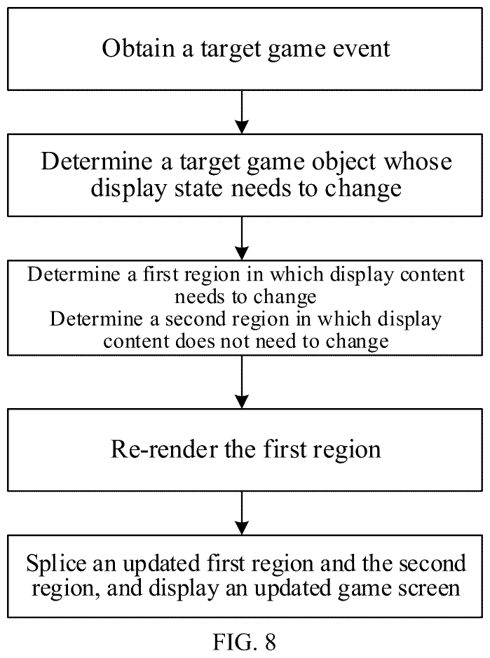

Therefore, to facilitate further understanding of the image rendering method provided in the embodiments of this application, the following exemplarily and entirely describes the image rendering method provided in the embodiments of this application. FIG. 8 is a schematic flowchart of an implementation of an image rendering method according to an embodiment of this application.

As shown in FIG. 8, a terminal device running a target game application may obtain a target game event that can cause a change in a currently displayed game screen. The target game event herein may include a local target game event and a remote target game event. The local target game event is an event generated by a use object of the terminal device triggering a related operation through the target game application. The remote target game event is a game event transmitted by a background server of the target game application, may be an event (such as a countdown event or an NPC control event) generated by the background server, or may be an event (such as a virtual character control event or a message transmission event) generated by another use object of the target game application.

The terminal device may determine, based on the obtained target game event, that a game object involved in the target game event is a target game object whose display status needs to change, and may further determine a change parameter of the target game object, that is, determine how the display status of the target game object changes.

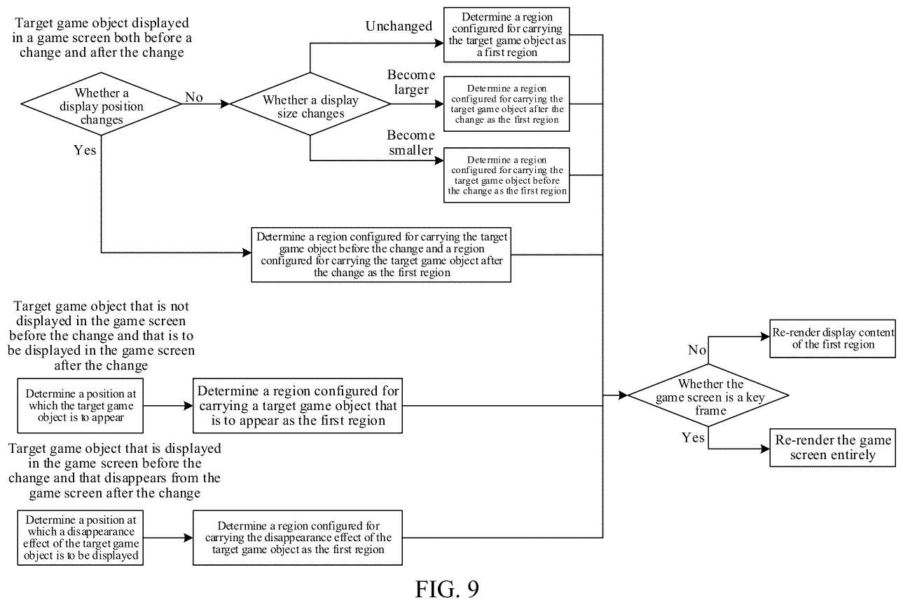

For each target game object, a region affected by the change of the target game object may be determined in a plurality of regions included in the game screen, that is, a first region involved in the target game object is determined. The game screen is divided into the plurality of regions in a preset division manner. An implementation process of specifically determining each first region in which each target game object is involved is shown in FIG. 9.

For a target game object displayed in the game screen both before and after the change, the terminal device may determine whether a display position of the target game object changes; and if the display position does not change, further determine whether a display size of the target game object changes. If the display size of the target game object does not change, a first region involved in the target game object is a region configured for carrying the current display position of the target game object. If the display size of the target game object becomes larger, the first region involved in the target game object is a region configured for carrying the target game object after the change. If the display size of the target game object becomes smaller, the first region involved in the target game object is a region configured for carrying the target game object before the change. When the display position changes, the terminal device may directly use both the region configured for carrying the target game object before the change and the region configured for carrying the target game object after the change as the first region involved in the target game object. For a target game object that is not displayed in the game screen before the change and that is displayed in the game screen after the change, the terminal device may determine a position at which the target game object is to appear in the game screen based on a change parameter of the target game object, and then determine, based on the position to appear at, a region configured for carrying the target game object that is to appear in the plurality of regions included in the game screen as the first region involved in the target game object. For a target game object that is displayed in the game screen before the change and that disappears from the game screen after the change, the terminal device may determine, based on a display position of the target game object in the game screen and a disappearance effect corresponding to the target game object, a position to display at of the disappearance effect corresponding to the target game object in the game screen, and then determine, based on the position to display at, a region configured for carrying the disappearance effect corresponding to the target game object in the plurality of regions included in the game screen as the first region involved in the target game object.

In this way, after each first region involved in each target game object is determined, the terminal device may perform key frame determining processing. In other words, the terminal device may determine a proportion that each first region occupies in regions included in the game screen; then determine whether the proportion exceeds a preset proportion threshold; and if the proportion exceeds the preset proportion threshold, determine that the game screen is a key frame, and the game screen needs to be entirely re-rendered, to obtain an updated game screen displayed in a next frame; or if the proportion does not exceed the preset proportion threshold, determine a region in the game screen other than the first region as a second region; only re-render display content of the first region, to obtain a corresponding first updated region; splice each first updated region corresponding to each first region and each second region, to obtain the updated game screen displayed in the next frame; and display the updated game screen through a screen of the terminal device.

For the image rendering method described above, this application further provides a corresponding image rendering apparatus, so that the image rendering method is actually applied and implemented.

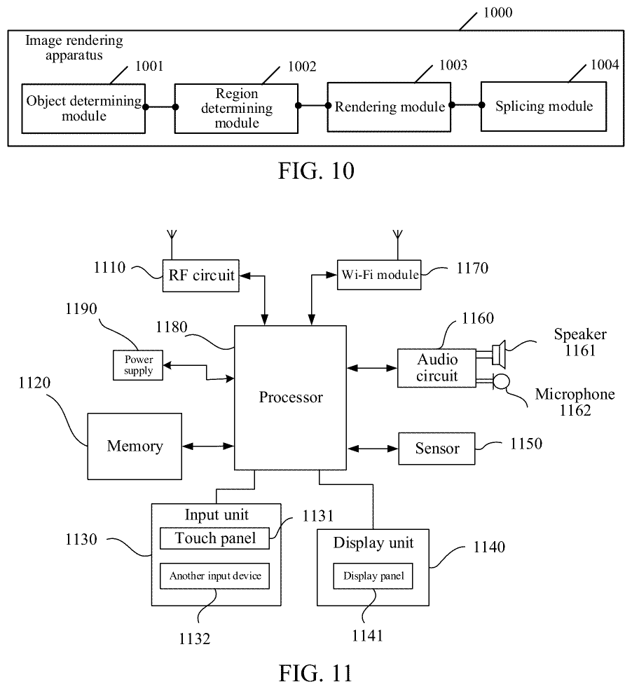

Referring to FIG. 10, FIG. 10 is a structural schematic diagram of an image rendering apparatus 1000 corresponding to the image rendering method shown in FIG. 2. As shown in FIG. 10, the image rendering apparatus 1000 includes:
an object determining module 1001, configured to determine a target game object and a change parameter of the target game object, the target game object being a game object that changes in a next frame in a currently displayed game screen;
a region determining module 1002, configured to determine, based on the change parameter of the target game object, a first region and a second region in a plurality of regions included in the game screen, the game screen being divided into the plurality of regions, the first region being a region in the game screen that is affected by the change parameter of the target game object in the next frame and in which display content is to change, and the second region being a region in the game screen that is not affected by the change parameter of the target game object in the next frame and in which display content does not change;
a rendering module 1003, configured to re-render the display content of the first region based on the change parameter of the target game object, to obtain a first updated region; and
a splicing module 1004, configured to splice the first updated region and the second region, to obtain an updated game screen displayed in the next frame.

In some embodiments, the region determining module 1002 is specifically configured to:
determine a first candidate region set in the plurality of regions based on a display position of the target game object in the currently displayed game screen, each first candidate region included in the first candidate region set being configured for carrying the target game object before the change;
determine a second candidate region set in the plurality of regions based on the display position and the change parameter of the target game object, each second candidate region included in the second candidate region set being configured for carrying the target game object after the change; and
determine the first region based on the change parameter of the target game object, the first candidate region set, and the second candidate region set, and determine the second region based on a region in the game screen other than the first region.

In some embodiments, the region determining module 1002 is specifically configured to:
determine each candidate region included in any candidate region set of the first candidate region set and the second candidate region set as the first region when the change parameter of the target game object represents that neither of the display position and a display size of the target game object changes.

In some embodiments, the region determining module 1002 is specifically configured to:
determine each first candidate region included in the first candidate region set and each second candidate region included in the second candidate region set as the first region when the change parameter of the target game object represents that the display position of the target game object changes.

In some embodiments, the region determining module 1002 is specifically configured to:
when the change parameter of the target game object represents that a display size of the target game object changes, and the display position does not change, determine each second candidate region included in the second candidate region set as the first region if the display size of the target game object becomes larger; or determine each first candidate region included in the first candidate region set as the first region if the display size of the target game object becomes smaller.

In some embodiments, the region determining module 1002 is specifically configured to:
determine, based on the change parameter of the target game object and when the target game object is a game object that does not appear in the game screen, a position at which the target game object is to appear in the next frame in the game screen; and
determine, in the plurality of regions, a region configured for carrying a target game object that is to appear as the first region based on the position to appear at; and determine the second region based on the plurality of regions except the first region.

In some embodiments, the region determining module 1002 is specifically configured to:
determine a position at which a disappearance effect of the target game object is to be displayed in the next frame of the game screen when the target game object is a game object that is to disappear in the next frame of the game screen and based on a display position of the target game object in the currently displayed game screen and the change parameter of the target game object; and
determine, in the plurality of regions, a region configured for carrying the disappearance effect of the target game object based on the position to display at as the first region; and determine the second region based on the plurality of regions except the first region.

In some embodiments, the apparatus further includes:
a proportion determining module, configured to determine a proportion that the first region occupies in the plurality of regions as a target proportion; and
a proportion judging module, configured to: re-render the display content of the game screen when the target proportion exceeds a preset proportion threshold, to obtain the updated game screen; and control the rendering module 1003 and the splicing module 1004 to perform corresponding operations when the target proportion does not exceed the preset proportion threshold.

In some embodiments, the apparatus further includes:
a scene determining module, configured to: re-render, when a scenario corresponding to the game screen is not a preset target scene, the display content of the game screen, to obtain the updated game screen; and control the region determining module 1002, the rendering module 1003, and the splicing module 1004 to perform corresponding operations when the scene corresponding to the game screen is the target scene.

In some embodiments, the rendering module 1003 is specifically configured to:
render an object layer corresponding to the target game object based on the change parameter of the target game object, to obtain a changed object layer of the first region, different object layers being obtained through division based on different game objects in a game process; and
perform superimpose processing on the changed object layer and an unchanged object layer of the first region, to obtain the first updated region.

In some embodiments, the region determining module 1001 is specifically configured to:
obtain a target game event, the target game event being an event that causes a change in the game screen;
determine a game object involved in the target game event as the target game object; and
determine the change parameter of the target game object based on an impact of the target game event on a display status of the target game object.

In the image rendering apparatus provided in the embodiments of this application, region division processing is performed on the game screen. The first region in which the display content needs to change and the second region in which the display content does not need to change are determined in the regions included in the game screen based on the change parameter of the target game object in the game. Then, only the display content of the first region is re-rendered, and the display content of the second region remains unchanged. In addition, the first updated region obtained through re-rendering and the second region are spliced, to obtain the updated game screen displayed in the next frame. Only the partial area in which the display content changes in the game screen is re-rendered, so that an amount of workload required to render the game screen can be reduced, a rendering duration of the game screen is shortened, and a higher frame rate is obtained. In addition, the foregoing method does not cause other losses to the game experience of the player, and the game experience can be fundamentally improved.

Embodiments of this application further provide an electronic device for image rendering. The electronic device may be specifically a terminal device or a server. The following describes the terminal device and the server provided in the embodiments of this application from a perspective of hardware materialization.

Referring to FIG. 11, FIG. 11 is a structural schematic diagram of a terminal device according to an embodiment of this application. As shown in FIG. 11, for case of description, only a part related to the embodiments of this application is shown. For specific technical details that are not disclosed, refer to the method part of the embodiments of this application. The terminal may be any terminal device including a smartphone, a tablet computer, a personal digital assistant (PDA), a point of sale (POS), a vehicle-mounted computer, and the like. For example, the terminal is the smartphone.

FIG. 11 is a block diagram of a partial structure of a smartphone related to a terminal according to an embodiment of this application. Referring to FIG. 11, the smartphone includes components such as a radio frequency (RF) circuit 1110, a memory 1120, an input unit 1130 (including a touch panel 1131 and another input device 1132), a display unit 1140 (including a display panel 1141), a sensor 1150, an audio circuit 1160 (which may be connected to a speaker 1161 and a microphone 1162), a wireless fidelity (Wi-Fi) module 1170, a processor 1180, and a power supply 1190. A person skilled in the art may understand that the structure of the smartphone shown in FIG. 11 does not constitute any limitation on the smartphone, and the smartphone may include more or fewer components than those shown in the figure, or some components may be combined, or different component arrangements.

The memory 1120 may be configured to store a software program and a module. The processor 1180 executes various functional applications and data processing of the smartphone by running the software program and the module stored in the memory 1120. The memory 1120 may mainly include a program storage area and a data storage area. The program storage area may store an operating system, an application required by at least one function (such as a sound playback function and an image playback function), or the like. The data storage area may store data (such as audio data and a phone book) created based on use of the smartphone, or the like. In addition, the memory 1120 may include a high-speed random access memory, and may further include a non-volatile memory, such as at least one magnetic disk storage device, a flash storage device, or another volatile solid-state storage device.

The processor 1180 is a control center of the smartphone, is connected to various parts of the entire smartphone by using various interfaces and lines, and executes various functions of the smartphone and processes data by running or executing a software program and/or a module stored in the memory 1120 and invoking data stored in the memory 1120. In some embodiments, the processor 1180 may include one or more processing units. Preferably, the processor 1180 may integrate an application processor and a modem processor. The application processor mainly processes an operating system, a user interface, an application, and the like. The modem processor mainly processes wireless communication. The foregoing modem processor may not be integrated into the processor 1180.

In this embodiment of this application, the processor 1180 included in the terminal is further configured to perform operations of any one implementation of the image rendering method provided in this embodiment of this application.

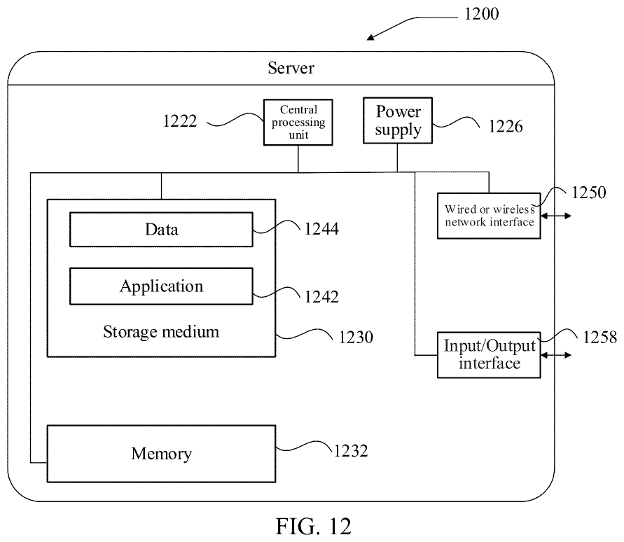

Referring to FIG. 12, FIG. 12 is a structural schematic diagram of a server 1200 according to an embodiment of this application. The server 1200 may vary greatly because of different configurations or performance, and may include one or more central processing units (CPUs) 1222 (for example, one or more processors), a memory 1232, and one or more storage media 1230 (for example, one or more mass storage devices) that store an application 1242 or data 1244. The memory 1232 and the storage medium 1230 may be temporarily stored or permanently stored. The program stored in the storage medium 1230 may include one or more modules (not marked in the figure), and each module may include a series of instruction operations on the server. Further, the central processing unit 1222 may be configured to communicate with the storage medium 1230, and execute a series of instructions and operations in the storage medium 1230 on the server 1200.

The server 1200 may further include one or more power supplies 1226, one or more wired or wireless network interfaces 1250, one or more input/output interfaces 1258, and/or one or more operating systems, such as Windows Server™, Mac OS X™, Unix™, Linux™, and FreeBSD™.

Operations performed by the server in the foregoing embodiment may be based on the server structure shown in FIG. 12.

The CPU 1222 may be further configured to perform operations of any implementation of the image rendering method provided in the embodiments of this application.

Embodiments of this application further provide a non-transitory computer-readable storage medium, configured to store a computer program, the computer program, when executed by a processor of a computer device, being configured to cause the computer device to perform any one of the implementations of the image rendering method according to the foregoing embodiments.

Embodiments of this application further provide a computer program product including a computer program, the computer program product, when run on a computer, causing the computer device to perform any one of the implementations of the image rendering method according to the foregoing embodiments.

A person skilled in the art may clearly understand that, for convenience and conciseness of description, for detailed work processes of the foregoing systems, apparatuses, and units, refer to the corresponding processes in the foregoing method embodiments. Details are not described herein again.

In the embodiments provided in this application, the disclosed system, apparatus, and method may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one place, or may be distributed on a plurality of network units.

Some or all of the units may be selected based on actual requirements to achieve the objectives of the solutions of the embodiments.

In addition, the functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related art, or all or a part of the technical solutions may be implemented in a form of a software product. The computer software product is stored in a storage medium, and includes several instructions for instructing a computer device (which may be a personal computer, a server, a network device, or the like) to perform all or some of the operations of the methods described in the embodiments of this application. The foregoing storage medium includes any medium that can store a computer program, such as a USB flash drive, a removable hard disk, a read-only memory (ROM), a random access memory (RAM), a magnetic disk, or an optical disc.

In this application, “at least one” means one or more, and “a plurality of” means two or more. The term “and/or” is used to describe an association relationship between associated objects and indicates that three relationships may exist. For example, “A and/or B” may indicate the following three cases: only A exists, only B exists, and both A and B exist. A and B may be singular or plural. The character “/” generally indicates an “or” relationship between the associated objects. “At least one of the following” or similar expressions refers to any combination of these items, including any combination of one item or a plurality of items. For example, at least one of a, b, or c may represent: a, b, or c, “a and b”, “a and c”, “b and c”, or “a and b and c”, where a, b, and c may be a single or plural.

The foregoing embodiments are merely intended for describing the technical solutions of this application, but not for limiting this application. Although this application is described in detail with reference to the foregoing embodiments, a person of ordinary skill in the art needs to understand that they may still make modifications to the technical solutions described in the foregoing embodiments or make equivalent replacements to some technical features thereof, without departing from the spirit and scope of the technical solutions of the embodiments of this application.

What is claimed is:

1. An image rendering method performed by a computer device, the method comprising:
determining, in a game screen, a target game object that changes in a next frame of the game screen and a corresponding change parameter of the game object;
dividing the game screen into a plurality of regions;
determining, among the plurality of regions, a first region and a second region based on the change parameter of the target game object;
re-rendering the first region based on the change parameter of the target game object, to obtain a first updated region; and
splicing the first updated region and the second region, to obtain an updated game screen displayed in the next frame.

2. The method according to claim 1, wherein the determining, among the plurality of regions, a first region and a second region based on the change parameter of the target game object comprises:
determining a first candidate region set in the plurality of regions based on a display position of the target game object in the currently displayed game screen, each first candidate region comprised in the first candidate region set being configured for carrying the target game object before the change;
determining a second candidate region set in the plurality of regions based on the display position and the change parameter of the target game object, each second candidate region comprised in the second candidate region set being configured for carrying the target game object after the change; and
determining the first region based on the change parameter of the target game object, the first candidate region set, and the second candidate region set, and determining the second region based on a region in the game screen other than the first region.

3. The method according to claim 2, wherein the determining the first region based on the change parameter of the target game object, the first candidate region set, and the second candidate region set comprises:
determining each candidate region comprised in any candidate region set of the first candidate region set and the second candidate region set as the first region when the change parameter of the target game object represents that neither of the display position and a display size of the target game object changes.

4. The method according to claim 2, wherein the determining the first region based on the change parameter of the target game object, the first candidate region set, and the second candidate region set comprises:
determining each first candidate region comprised in the first candidate region set and each second candidate region comprised in the second candidate region set as the first region when the change parameter of the target game object represents that the display position of the target game object changes.

5. The method according to claim 2, wherein the determining the first region based on the change parameter of the target game object, the first candidate region set, and the second candidate region set comprises:
when the change parameter of the target game object represents that a display size of the target game object changes, and the display position does not change, determining each second candidate region comprised in the second candidate region set as the first region if the display size of the target game object becomes larger; or determining each first candidate region comprised in the first candidate region set as the first region if the display size of the target game object becomes smaller.

6. The method according to claim 1, wherein the determining, among the plurality of regions, a first region and a second region based on the change parameter of the target game object comprises:
when the target game object does not appear in the game screen, determining, based on the change parameter of the target game object, a position at which the target game object is to appear in the next frame in the game screen;
determining, among the plurality of regions, a region in which the target game object is to appear as the first region based on the position at which the target game object is to appear in the next frame in the game screen; and
determining the second region based on the plurality of regions except the first region.

7. The method according to claim 1, wherein the determining, among the plurality of regions, a first region and a second region based on the change parameter of the target game object comprises:
determining a position at which a disappearance effect of the target game object is to be displayed in the next frame of the game screen when the target game object is a game object that is to disappear in the next frame of the game screen and based on a display position of the target game object in the currently displayed game screen and the change parameter of the target game object; and
determining, among the plurality of regions, a region configured for carrying the disappearance effect of the target game object based on the position to display at as the first region; and determining the second region based on the plurality of regions except the first region.

8. The method according to claim 1, wherein the method further comprises:
determining a proportion that the first region occupies in the plurality of regions as a target proportion;
re-rendering the display content of the game screen when the target proportion exceeds a preset proportion threshold, to obtain the updated game screen; and
performing, when the target proportion does not exceed the preset proportion threshold, the operation of re-rendering the display content of the first region based on the change parameter of the target game object, to obtain a first updated region.

9. The method according to claim 1, wherein the method further comprises:
re-rendering, when a scenario corresponding to the game screen is not a preset target scene, the display content of the game screen, to obtain the updated game screen; and
performing, when the scene corresponding to the game screen is the preset target scene, the operation of determining, based on the change parameter of the target game object, a first region and a second region in a plurality of regions comprised in the game screen.

10. The method according to claim 1, wherein the re-rendering the first region based on the change parameter of the target game object, to obtain a first updated region comprises:
rendering an object layer corresponding to the target game object based on the change parameter of the target game object, to obtain a changed object layer of the first region, different object layers being obtained through division based on different game objects in a game process; and
superimposing an unchanged object layer of the first region on the changed object layer to obtain the first updated region.

11. A computer device comprising a processor and a memory;
the memory being configured to store a computer program; and
the processor being configured to perform, based on the computer program, an image rendering method including:
determining, in a game screen, a target game object that changes in a next frame of the game screen and a corresponding change parameter of the game object;
dividing the game screen into a plurality of regions;
determining, among the plurality of regions, a first region and a second region based on the change parameter of the target game object;
re-rendering the first region based on the change parameter of the target game object, to obtain a first updated region; and
splicing the first updated region and the second region, to obtain an updated game screen displayed in the next frame.

12. The computer device according to claim 11, wherein the determining, among the plurality of regions, a first region and a second region based on the change parameter of the target game object comprises:
determining a first candidate region set in the plurality of regions based on a display position of the target game object in the currently displayed game screen, each first candidate region comprised in the first candidate region set being configured for carrying the target game object before the change;
determining a second candidate region set in the plurality of regions based on the display position and the change parameter of the target game object, each second candidate region comprised in the second candidate region set being configured for carrying the target game object after the change; and
determining the first region based on the change parameter of the target game object, the first candidate region set, and the second candidate region set, and determining the second region based on a region in the game screen other than the first region.

13. The computer device according to claim 12, wherein the determining the first region based on the change parameter of the target game object, the first candidate region set, and the second candidate region set comprises:
determining each candidate region comprised in any candidate region set of the first candidate region set and the second candidate region set as the first region when the change parameter of the target game object represents that neither of the display position and a display size of the target game object changes.

14. The computer device according to claim 12, wherein the determining the first region based on the change parameter of the target game object, the first candidate region set, and the second candidate region set comprises:
determining each first candidate region comprised in the first candidate region set and each second candidate region comprised in the second candidate region set as the first region when the change parameter of the target game object represents that the display position of the target game object changes.

15. The computer device according to claim 12, wherein the determining the first region based on the change parameter of the target game object, the first candidate region set, and the second candidate region set comprises:
when the change parameter of the target game object represents that a display size of the target game object changes, and the display position does not change, determining each second candidate region comprised in the second candidate region set as the first region if the display size of the target game object becomes larger; or determining each first candidate region comprised in the first candidate region set as the first region if the display size of the target game object becomes smaller.

16. The computer device according to claim 11, wherein the determining, among the plurality of regions, a first region and a second region based on the change parameter of the target game object comprises:
when the target game object does not appear in the game screen, determining, based on the change parameter of the target game object, a position at which the target game object is to appear in the next frame in the game screen;
determining, among the plurality of regions, a region in which the target game object is to appear as the first region based on the position at which the target game object is to appear in the next frame in the game screen; and
determining the second region based on the plurality of regions except the first region.

17. The computer device according to claim 11, wherein the determining, among the plurality of regions, a first region and a second region based on the change parameter of the target game object comprises:
determining a position at which a disappearance effect of the target game object is to be displayed in the next frame of the game screen when the target game object is a game object that is to disappear in the next frame of the game screen and based on a display position of the target game object in the currently displayed game screen and the change parameter of the target game object; and
determining, among the plurality of regions, a region configured for carrying the disappearance effect of the target game object based on the position to display at as the first region; and determining the second region based on the plurality of regions except the first region.

18. The computer device according to claim 11, wherein the method further comprises:
determining a proportion that the first region occupies in the plurality of regions as a target proportion;
re-rendering the display content of the game screen when the target proportion exceeds a preset proportion threshold, to obtain the updated game screen; and
performing, when the target proportion does not exceed the preset proportion threshold, the operation of re-rendering the display content of the first region based on the change parameter of the target game object, to obtain a first updated region.

19. The computer device according to claim 11, wherein the re-rendering the first region based on the change parameter of the target game object, to obtain a first updated region comprises:
rendering an object layer corresponding to the target game object based on the change parameter of the target game object, to obtain a changed object layer of the first region, different object layers being obtained through division based on different game objects in a game process; and
superimposing an unchanged object layer of the first region on the changed object layer to obtain the first updated region.

20. A non-transitory computer-readable storage medium, storing a computer program, and the computer program, when executed by a processor of a computer device, being configured to cause the computer device to perform an image rendering method including:
determining, in a game screen, a target game object that changes in a next frame of the game screen and a corresponding change parameter of the game object;
dividing the game screen into a plurality of regions;
determining, among the plurality of regions, a first region and a second region based on the change parameter of the target game object;
re-rendering the first region based on the change parameter of the target game object, to obtain a first updated region; and
splicing the first updated region and the second region, to obtain an updated game screen displayed in the next frame.
